(19) United States
(12) Patent Application Publication
(10) Pub. No.: US 2004/0032032 A1
(43) Pub. Date: Feb. 19, 2004

(54) Method and apparatus for making compost tea

(75) Inventor: Jerry Erickson, Bainbridge Island, WA (US)

Correspondence Address: John Russell Uren, P. Eng., Suite 202, 1590 Bellevue Avenue, West Vancouver, BC, V7V 1A7, CA

(73) Assignee: SOILSOUP INC.

(21) Appl. No.: 10/435,599

(22) Filed: May 9, 2003

Related U.S. Application Data
(63) Continuation-in-part of application No. 09/405,288, filed on Sep. 23, 1999, now Pat. No. 6,520,490.
(63) Continuation-in-part of application No. 10/349,677, filed on Jan. 22, 2003.
(62) Division of application No. 09/405,288, filed on Sep. 23, 1999, now Pat. No. 6,520,490.

(51) Int. Cl. B01F 3/04

(52) U.S. Cl. 261/93; 71/6

(57) ABSTRACT

A method and apparatus for producing a liquid compost material. A starter compost material is added to water within a first tank and nutrients are further added. The materials are aerated for a first known time period to facilitate bacterial breakdown until the formation of the liquid compost material or tea is complete whereupon a portion of the tea is removed. Water is added together with nutrients to the remaining tea in the tank and aeration continues for a second and much smaller time period. Liquid compost material is again formed in the tank within the second time period.

This application relates to manufacturing a liquid compost material or compost “tea” and, more particularly, to the manufacture of such compost tea and to the product made according to the process.

### BACKGROUND OF THE INVENTION

The use of compost to manufacture a liquid compost material or compost “tea” for use as a soil treatment or additive is known. Reference is made to our co-pending application Ser. No. 09/405,288, now issued as U.S. Pat. No. 6,520,490, in which a process and an apparatus for manufacturing such compost tea is described. The manufacture of such a tea is useful in order to provide organic nutrients to a soil. The resulting compost tea itself rather than the process used to make the tea has resulted in a product which is in considerable demand due at least in part to environmental considerations.

There are, however, problems associated with the manufacture of such a compost tea sold as a retail product. The compost tea sold there is normally processed in batches; that is, the tea is made in individual batches one at a time rather than in a continuous process. First, in such batch production, employees had to be trained to have the tea available at peak customer hours. This took employee time more usefully given to other tasks. Secondly, ambient temperatures are a criteria in the production of such tea and such ambient temperatures differ widely depending on the time of day and the season thereby affecting the consistency and timing of the tea produced by the process. Thirdly, demand for the compost tea usually was at a peak on weekends in gardening centers and the like and it was difficult to manufacture and store such tea in a sufficient quantity only for those days. Further, the apparatus used to produce such tea for the weekends would sit unused for a substantial portion of the week. Finally, cleaning and restarting each system between batches is labor intensive and time consuming. Other problems inherent in the batch process included the degradation of the product after a certain period of time when the product was merely held in a holding tank with no further treatment taking place.

In prior art continuous systems used to manufacture a liquid compost material or tea, electrical conductivity of the solution or it's pH has normally been used to determine when the bacterial breakdown has reached the optimal value which will allow the product to be removed from the tank in which the aerobic breakdown has occurred. When the pH or electrical conductivity dictates that the product can be continually drawn off from the tank, the nutrients and water are again added together to form a continuous flow. This is disadvantageous since the process is unduly complicated.

In experimental results, it has been found that there are two aspects of a liquid compost manufacturing process that can be useful. The first finding is that if only a portion of the “brewed” compost material is removed from a tank where such brewing has occurred, the remaining material in the tank will facilitate the generation of bacteria for second and subsequent batches in a much shorter time period and further starter material is not required for the process although the addition of nutrients is so required. The second finding is that if the brewed tea is continuously aerated following its creation, it will not breakdown or deteriorate and can thereby be held for extended time periods.

The use of bubbles for assisting in the aeration of a liquid compost waste solution is well known. Such a process used in the liquid composting process is called an aerobic process and utilises oxygen in breaking down sewage and like materials. This is as opposed to the non-oxygen or anaerobic process of bacterial breakdown. The use of aeration in bacterial breakdown enhances the breakdown action. Following the bacterial breakdown of waste material into components, some of such components may be used as fertilizer which otherwise can be expensive. Thus, bacterial breakdown of waste materials can be attractive.

The aeration action using bubbles typically uses a bubble generator. Water or other liquid is mixed with the compost and bubbles are generated beneath the surface of the liquid. These bubbles rise to the surface and, in so doing, distribute air within the compost-liquid mix. The air then aerates the mix and assists in the bacterial breakdown.

U.S. Pat. No. 3,778,233 (Blough et al), for example, discloses an elongated hollow shaft with a propeller secured to one end, which propeller is immersed in the liquid waste material. The operation of the propeller induces bubbles and movement within the waste material which enhances the aerobic process. A further example of a propeller system is described and illustrated in U.S. Pat. No. 4,240,990 (Inhofer et al).

The bubbles generated by the apparatuses of the above-identified and other known prior art are generated by propeller action. That is, propellers are immersed in the compost-liquid mix and revolved, often at relatively high speeds. The revolving action of the propellers causes turbulence within the mixture and the concomitant generation of bubbles. The bubbles assist in dispersing oxygen throughout the mixture which, as discussed, enhances the efficacy of the aeration action in breaking down the compost.

The aeration action generates bubbles that are relatively small. The smaller the bubbles, the more numerous they will be which results in a greater total surface area of the air bubbles. This greater surface area of the bubbles will result in more air being dispersed throughout the compost/liquid mix. Smaller bubbles will also rise more slowly to the surface and will therefore be dispersed more uniformly throughout the mix and over a greater area.

Propellers generate bubbles that are relatively large, even at high speeds of revolution. And, of course, the relatively large diameter of the propellers used for bubble generation does limit the speed of rotation. While the relatively large bubbles do assist aerobic action, the bubbles rise to the surface quickly and are not, therefore, dispersed widely throughout the compost/liquid mixture.

### SUMMARY OF THE INVENTION

According to one aspect of the invention, there is provided a method for the production of a liquid compost material used as a soil amendment or soil treatment comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material and removing a predetermined quantity of said liquid compost material as a product following said predetermined time period.

According to a further aspect of the invention, there is provided a method for the production of a liquid compost material used as a soil amendment or soil treatment comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material, removing a predetermined quantity of said liquid compost material as a product following said predetermined time period and adding a second charge of nutrients to said water holding tank following said removal of said quantity of said liquid compost material.

According to yet a further aspect of the invention, there is provided a product produced by any one of the aforementioned methods.

According to still yet a further aspect of the invention, there is provided apparatus for producing a liquid compost material used as a soil amendment or a soil treatment comprising a first liquid and starter compost holding tank, a water addition apparatus for adding water to said tank, a nutrient addition apparatus for adding nutrients to said tank, an aerator for aerating the contents of said tank, a timer for indicating the elapse of a predetermined time period wherein bacterial breakdown of said starter compost and added nutrients is substantially complete and said liquid compost material has been produced and a liquid compost removal apparatus for removing a quantity of said liquid compost material following said predetermined time period.

According to yet a further aspect of the invention, there is provided apparatus for producing a liquid compost material used as a soil amendment or a soil treatment comprising a first liquid and starter compost holding tank, a water addition apparatus for adding water to said tank, a nutrient addition apparatus for adding nutrients to said tank, an aerator for aerating the contents of said tank, a timer for indicating the elapse of a predetermined time period wherein bacterial breakdown of said starter compost is substantially complete and said liquid compost material has been produced, a liquid compost removal apparatus for removing a quantity of said liquid compost material following said predetermined time period from said tank and a nutrient addition apparatus for adding a second charge of nutrients to said tank following removal of said quantity of liquid compost material after said predetermined time period.

According to yet a further aspect of the invention, there is provided a method for the production of a liquid compost material used as a soil amendment or soil treatment, said method comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material, removing a predetermined quantity of said liquid compost material as a product following said predetermined time period and adding a second charge of nutrients to said water holding tank following said removal of said quantity of said liquid compost material.

According to yet a further aspect of the invention, there is provided apparatus for producing a liquid compost material used as a soil amendment or a soil treatment comprising a first liquid and starter compost holding tank means for holding said first liquid, starter compost and nutrients, a water addition means for adding water to said tank, a nutrient addition means for adding nutrients to said tank, an aerator means for aerating the contents of said tank, a timer means for indicating the elapse of a predetermined time period wherein bacterial breakdown of said starter compost is substantially complete and said liquid compost material has been produced, a liquid compost removal means for removing a quantity of said liquid compost material following said predetermined time period from said tank and a nutrient addition means for adding a second charge of nutrients to said tank following removal of said quantity of liquid compost material after said predetermined time period.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic side view of the liquid compost aerator according to one aspect of the present invention, such aerator being in its operating position within a container holding the liquid/compost mixture which is intended to be aerated;

FIG. 2 is a diagrammatic side sectional view of the liquid compost aerator of FIG. 1 without the aerator housing cover thereby illustrating the inside components of the aerator;

FIG. 3 is an enlarged diagrammatic sectional side view of the components of the aerator pump located in the lower area of the liquid compost aerator;

FIG. 4 is an enlarged diagrammatic sectional side view of the components of the aerator pump located in the lower area of the liquid compost aerator according to a further embodiment of the invention;

FIG. 5 is an enlarged diagrammatic sectional side view of the assembled individual components of the aerator pump located in the lower area of the liquid compost aerator for manufacturing and assembly purposes;

FIG. 6 is an enlarged diagrammatic sectional side view of a liquid compost aerator according to a further aspect of the invention;

FIG. 7 is an enlarged diagrammatic sectional side view of a liquid compost aerator according to yet a further embodiment of the invention;

FIG. 8 is an enlarged diagrammatic sectional side view of a liquid compost aerator according to still yet a further embodiment of the invention;

FIG. 9 is an enlarged diagrammatic sectional side view of a liquid compost aerator according to yet a further aspect of the invention;

FIG. 10 is an enlarged diagrammatic detail side view of the vortex generator with specific dimensions shown thereon in an illustrative embodiment;

FIG. 11 is a diagrammatic exploded view of the aerator pump particularly illustrating the specific parts of the pump;

FIG. 12 is a diagrammatic schematic of a continuous liquid compost production system used to form the liquid compost material or compost “tea” according to a further aspect of the invention; and

FIGS. 13A, 13B and 13C are sequence listings of the semi-automated process under which the processing system is conducted and controlled.

### DESCRIPTION OF SPECIFIC EMBODIMENT

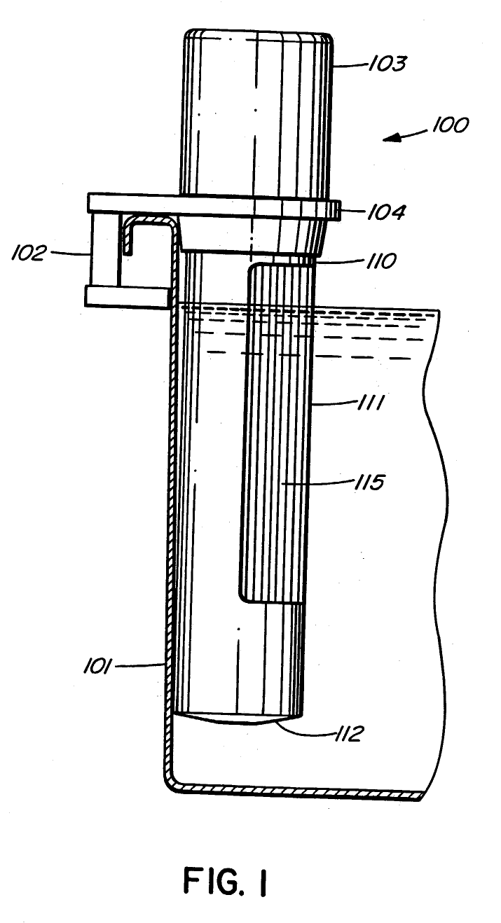

Referring now to the drawings, a liquid compost aerator according to one aspect of the invention is illustrated generally at 100 in FIG. 1. The aerator 100 is removably connected to a container 101 with a clamp 102. Container 101 holds the compost material and liquid sought to be aerated by the compost aerator 100. Container 101 may be any suitable size but containers of from five(5) gallons or larger are envisioned.

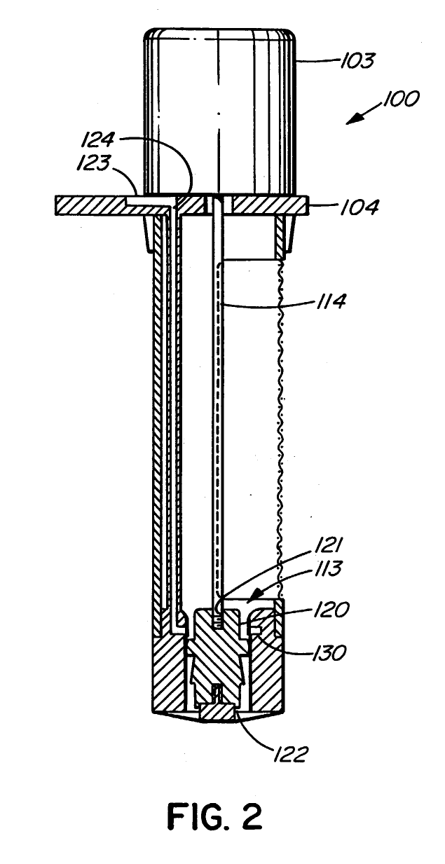

A motor 103 is mounted in the upper area of the compost aerator 100 to a collar 104 and clamp 102 is connected to collar 104. A casing 110 is mounted below collar 104 and encloses the aerator components within the casing 110, such components to be described. Casing 110 has a circumferential opening 111 which allows liquid within container 101 to enter the compost aerator 100. A mesh 115 is suitably positioned to be concentric to circumferential opening 111. Mesh 115 has openings to allow the ingress of liquid to the inside of the compost aerator 100 from container 101 but which prevents larger debris from entering the aerator 100. Casing 110 also contains an bottom opening 112. Bottom opening 112 allows the air/liquid mixture with the generated bubbles from the aerator pump generally illustrated at 113 (FIG. 2) to exit from the casing 110 as will be described.

Referring now to FIG. 2, the motor 103 has an attached shaft 114 which is rotated by the rotor 103 when the motor 103 is under operation. Shaft 114 is longitudinal and is connected at its distant end to the upper end of a rotor 120, conveniently by the use of a threaded connection 121. The bottom of rotor 120 is mounted on a stationary bearing 122 so as the shaft 114 rotates, rotor 120 similarly rotates on bearing 122.

An air inlet 123 is provided in collar 104 and an air passageway 124 extends from the air inlet 123 downwardly to the aerator pump 113. Air enters the aerator pump 113 from a circumferential passageway or plenum 130 communicating with air passageway 124 as will be described.

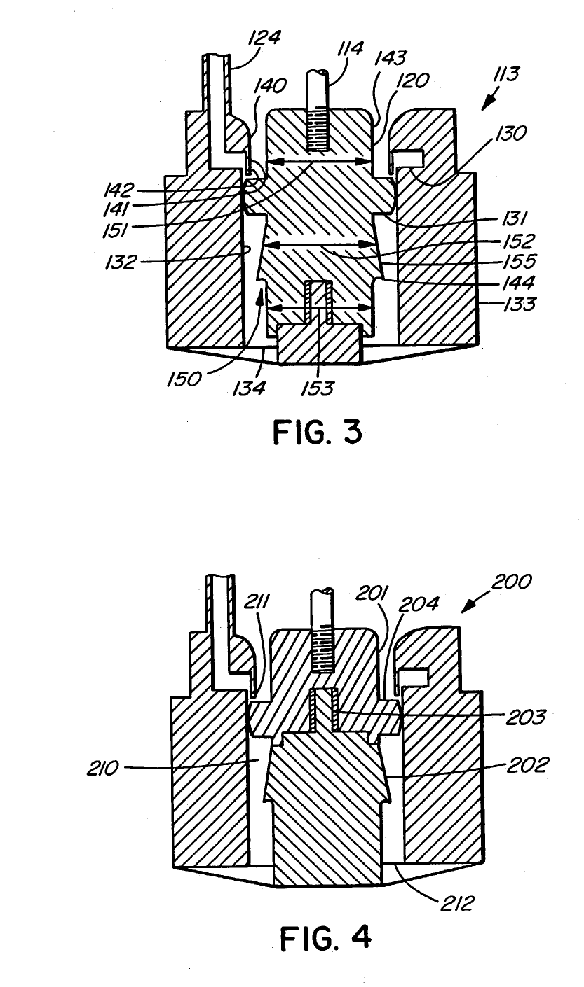

Reference is now made to FIG. 3 wherein the aerator pump 113 is illustrated in greater detail. A plurality of impeller blades 131 is attached to rotor 120 and rotates with rotor 120 when the shaft 114 is rotated by motor 103.

Rotor 120 rotates within a circular opening 132 machined within a block of material 133, conveniently a non-corrosive stainless steel, plastic material or the like. The air plenum 130 is likewise machined within block 133 and connects with the air passageway 124. The diameter of the circular opening 132 in the lower area of block 133 is constant and slightly larger than the outside diameter of the tips of the impeller blades 131 in the area from the bottom of air plenum 13 to the outlet opening 134.

Upstream of the impeller blades 131, a circular opening 140 having a slightly smaller diameter than the diameter of circular opening 132 is formed. This opening 140 extends downwardly and slightly overlaps with the commencement of circular opening 132. The bottom thereby forms a skirt 141 over air plenum 130 leaving a narrow circular slit 142 which allows the air in air plenum 130 to be released along the outside diameter of circular opening 132 slightly upstream of the impeller blades 131.

The shape of rotor 120 contributes to the formation of the aerated bubbles and will be discussed in detail. Beginning at the upper end 143 of rotor 120, the uppermost diameter 151 of the rotor 120 is constant and extends downwardly until the area of attachment of the impeller blades 131 is reached. This intermediate diameter 152 then increases by a relatively constant amount in a skirt type configuration until the lowermost portion, edge or tip 144 of the increased diameter is reached. This lowermost portion or tip 144 is a sharp edge and defines the outer and widest diameter of the vortex generator generally illustrated at 150. A radius extends from the tip 144 inwardly where it smoothly joins with a lower diameter 153 having approximately the same dimension as the upper diameter 151. A typical embodiment for a rotor 120 with specific dimensions shown for reference purposes is illustrated in the detail of FIG. 10.

### Operation

In operation, the compost aerator 100 is positioned within the container 101 as viewed in FIG. 1 and the clamp 102 is securely tightened to maintain the aerator 100 in position during operation. The motor 103 is then switched on and as it commences to turn shaft 114, rotor 120 will begin to turn within the circular opening 132 of block 133 on bearing 122.

The liquid within the container 101, having entered into the interior of casing 110 through mesh 115, will pass downwardly through the annular channel formed between the outside diameter 151 of rotor 120 and the diameters of circular openings 132 and 140, the velocity of the liquid increasing because of the transporting effect of the impeller blades 131 and the reduction of the area of the annular channel as the intermediate diameter 152 increases downwardly towards the vortex generator 150 from the upstream to the downstream end of the skirt 155.

The air from air plenum 130 is drawn from the plenum 130 by the suction created by the moving liquid and enters the annular channel along the outside diameter of circular opening 132.

The abrupt increase in area of the annular channel downstream of tip or edge 144 creates significant turbulence within the liquid and the air is formed into countless small bubbles which are distributed throughout the liquid from the tip or edge 144 to the outlet opening 134 of the aerator pump 113 where the bubbles are released into the liquid within the container 101. The bubbles, being very small, rise to the surface slowly and are therefore dispersed widely within the container 101. The aeration assists in the aforementioned bacterial breakdown.

A further embodiment of the invention is illustrated in FIG. 4. Specifically, the FIG. 4 embodiment of the aerator pump 200 is illustrated with the rotor 201 formed in a smaller piece although the effect is similar to the effect of the aerator pump 113 of FIG. 3.

In the FIG. 4 embodiment, the vortex generator 202 does not rotate with the rotor 201 but, rather, it remains stationary and acts as a mount for bearing 203. During operation, the liquid again flows by the impeller blades 204 through annular channel 210 and the air is similar released from circular slit 211. The action of the vortex generator 202 is precisely the same as the action with the vortex generator 150 of the first embodiment; that is, the liquid and entrained air will suddenly expand immediately downstream of the vortex generator 202 with significant turbulence thereby generating the desired bubbles with such bubbles being dispersed from the outlet end 212 of the aerator pump 200.

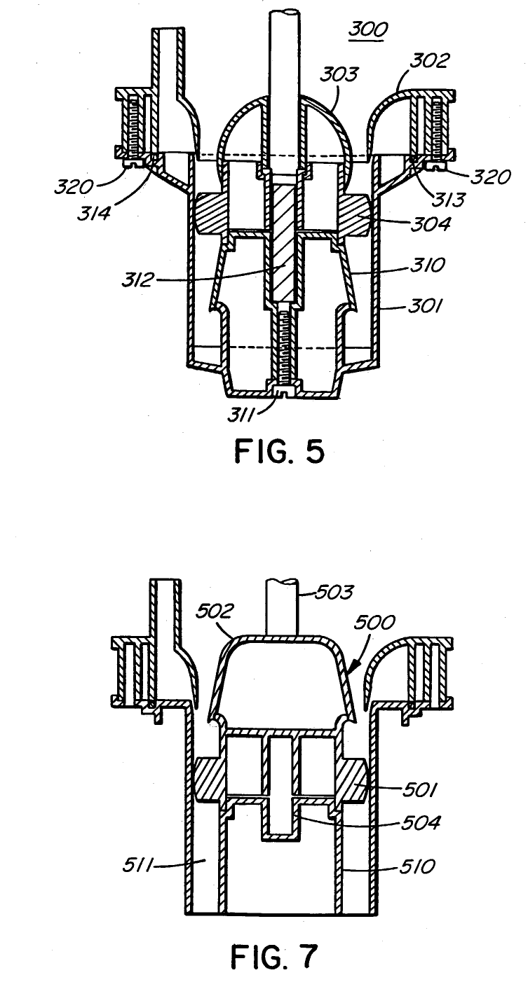

A convenient construction or assembly of the aerator pump 300 is illustrated in FIG. 5. In this embodiment, the assembly 300 is made primarily from injection molded thermo-plastic material which molding process requires a substantially uniform wall thickness where possible to ensure uniform shrinkage. The molded parts include the pump housing 301, the air inducer and plenum 302, the upper rotor housing and shaft coupling 303, the rotor with the impeller blades 304 and the vortex generator which includes the bearing holder 310.

The FIG. 5 apparatus is intended as a sub-assembly. The sequential assembly would include connecting the pump housing 301 and vortex generator 310 with a screw or bolt 311. The shaft 312 is glued in place using an adhesive, conveniently LOCTITE adhesive. The rotor 304 is then placed on the shaft 312 and an o-ring 313 is placed in groove 314 and the air inducer and plenum 302 is fastened to the pump housing 301 with screws 321, conveniently four(4). Thus, the rotor 304 is captive and the upper rotor housing and shaft housing 302 couples the drive shaft 312 to the rotor 304 by a keyed or splined fit.

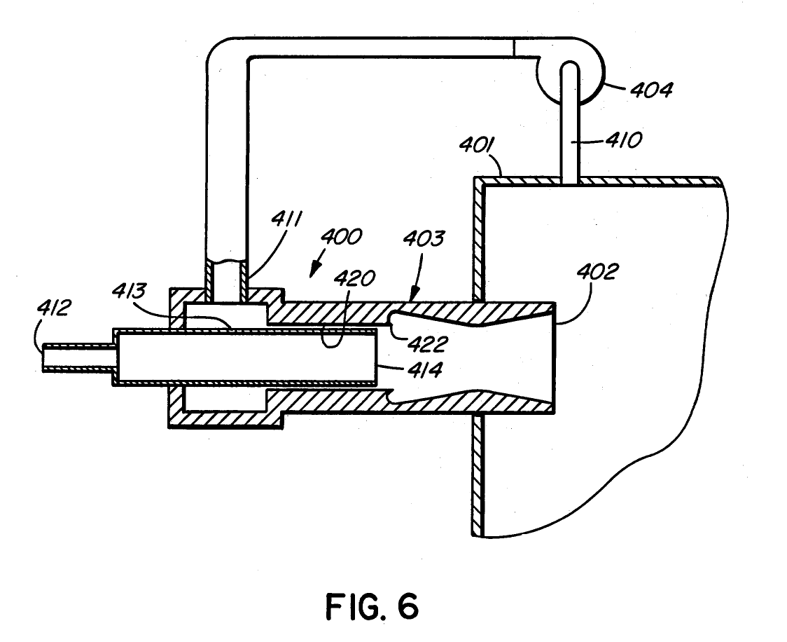

Yet a further embodiment of the compost aerator 400 is illustrated in FIG. 6. In this embodiment, the bulk of the compost aerator 400 is not within the container 401. Rather, only the outlet 402 of the aerator pump 403 extends into the container 401. Likewise, the use of impellers to induce flow past the vortex generator is replaced with a pump which likewise induces flow so the impellers are not required. In the FIG. 6 embodiment, the vortex generator 422 does not spin. Such spinning action is not seen as being necessary where liquid flow inducement past the vortex generator is done by an apparatus other than the revolving impellers and rotor of the earlier embodiments. A pump 404 is connected to a first conduit 410 which pumps liquid from container 401 to the liquid inlet 411 of compost aerator 400. Air is brought into the compost aerator 400 from air inlet 412 and the air is entrained with the liquid downstream from the outlet 414 of the air conduit 413 but upstream of the vortex generator or edge 422. The air is released from the air outlet 414 inside the outer diameter of the liquid channel 420. This is dissimilar to the first and second embodiments described earlier where the air is released along the outside of the liquid channel but the turbulence generated in such embodiment is believed to be similar to that generated in the first and second embodiments. The liquid flows through the liquid carrying channel 420 and is adjacent the tip 422 of the vortex generator when the channel 420 expands, in a manner similar to the first and second embodiments.

FIG. 7 illustrates a further embodiment of the invention. In this embodiment, the vortex generator generally illustrated at 500 is located upstream of the impeller 501. The rotor 502 is rotated by shaft 503 and turns on bearing 504 which is positioned in stationary base piece 510. In operation of the FIG. 7 embodiment, the impeller 501 draws the liquid and entrained air bubbles created by the turbulence adjacent the vortex generator 500 through the channel 511.

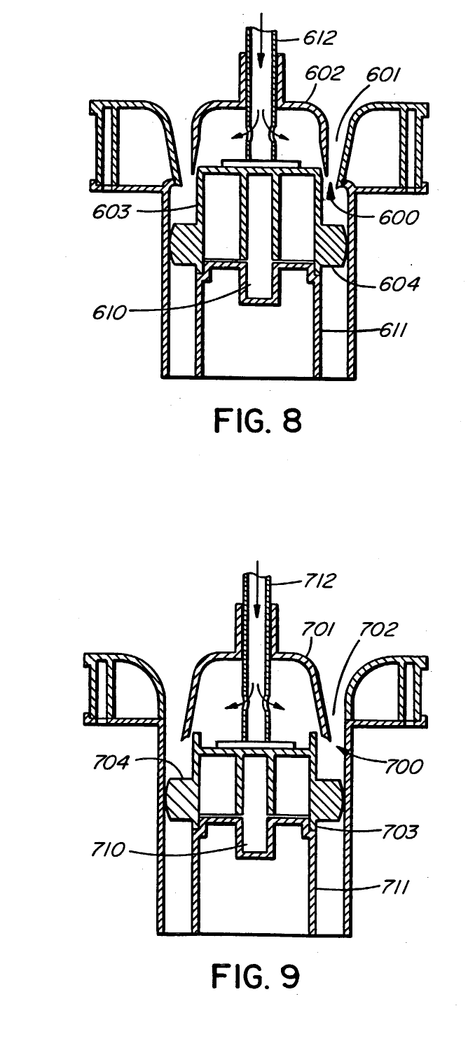

Yet a further embodiment of the invention is illustrated in FIG. 8. In this embodiment, the vortex generator generally illustrated at 600 is formed in the outer wall of the liquid channel 601 and the housing 602 which allows the egress of air into the liquid channel 601 is rotating and is connected to rotor 603 with its attached impeller blades 604 rotates on bearing 610 on stationary base 611 by way of rotating shaft 612 which also serves as the air conduit into housing 602.

In operation, the impeller blades 604 draw the liquid through the liquid channel 601 and the air is released from housing 602 into the liquid traveling through channel 601. Turbulence around the vortex generator 600 creates the air bubbles which then are emitted from the liquid channel 601 downstream of impeller blades 604.

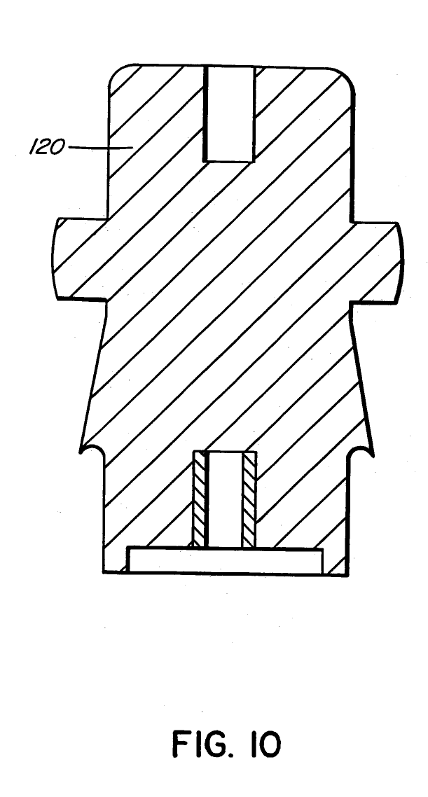

The embodiment illustrated in FIG. 9 utilises a vortex generator generally illustrated at 700 and wherein the air is released from the housing 701 into the vortex generator 700 precisely where the turbulence is created by the liquid traveling through the liquid channel 702 and with the channel 702 suddenly expanding downstream from the vortex generator 700. The rotor 703 with its attached impeller blades 704 rotates on bearing 710 which is positioned in stationary base 711 and is connected to the housing 701 which is likewise rotating. The air passes to the housing 701 through the shaft 712 which also rotates rotor 703.

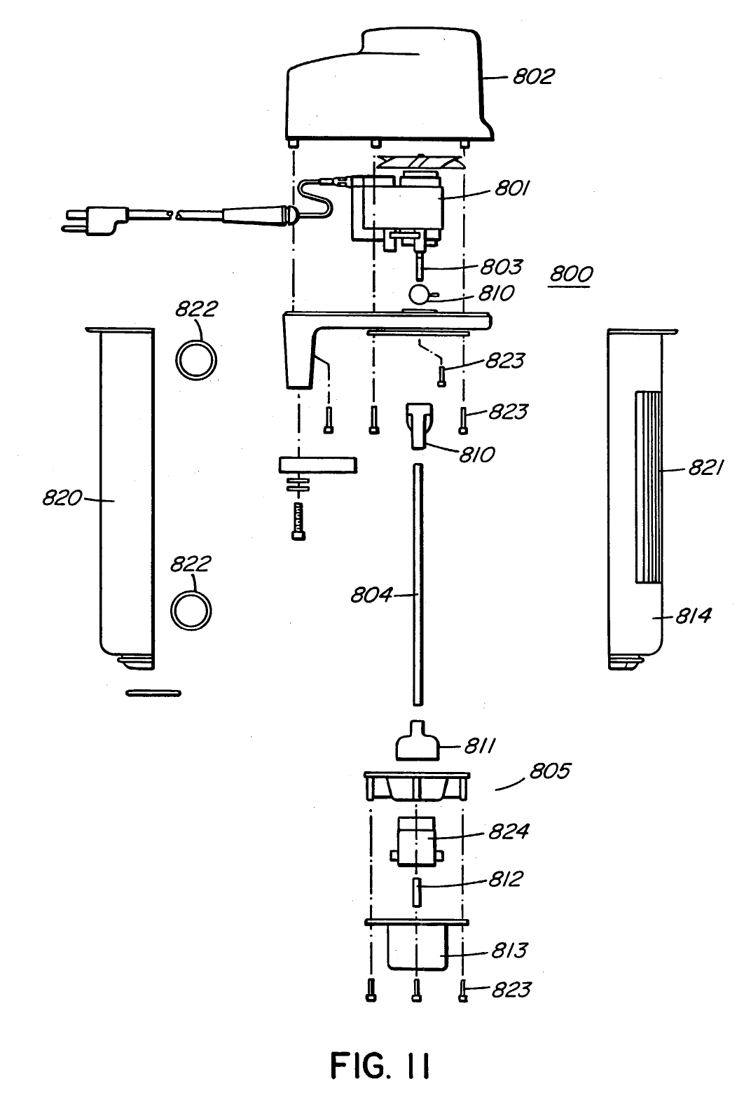

FIG. 11 illustrates the specific parts which make up the aerator generally illustrated at 800 with the vortex generator being generally illustrated at 805. An electrical motor 801 is mounted within the motor housing 802 and a drive shaft 803 extends from motor 801. Shaft 804 is hollow and is joined with upper connection 810 (two(2) components) and coupling 811 with adhesive, conveniently LOCTITE (Trademark). Likewise, the bearing 812 on which the rotor 824 rotates is mounted in base 813 similarly using LOCTITE adhesive. The housing comprises two halves 814, 820. Housing half 814 has an inlet 821 to admit the liquid from the compost container and o-rings 822 act as fasteners in connecting the components of the aerator 800 and a plurality of screws 823 is used to secure the components of the aerator 800.

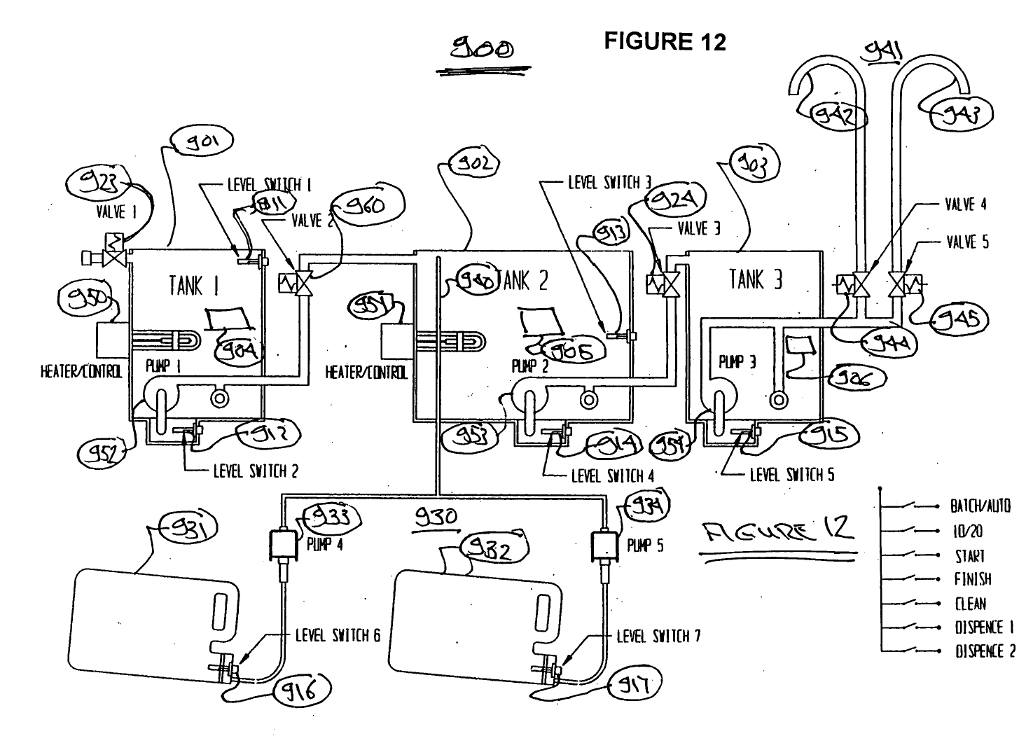

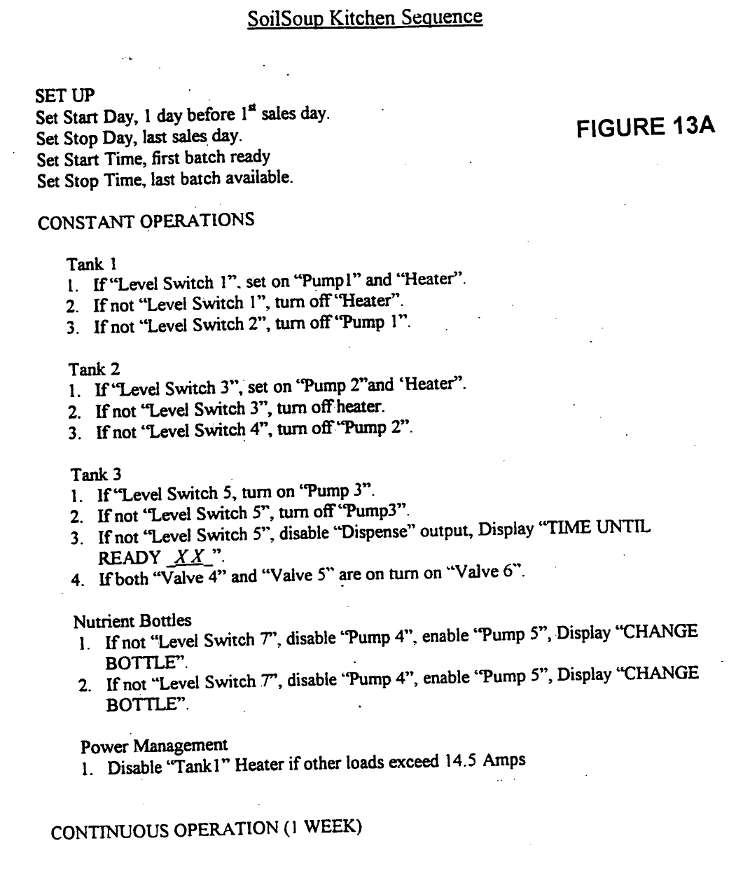

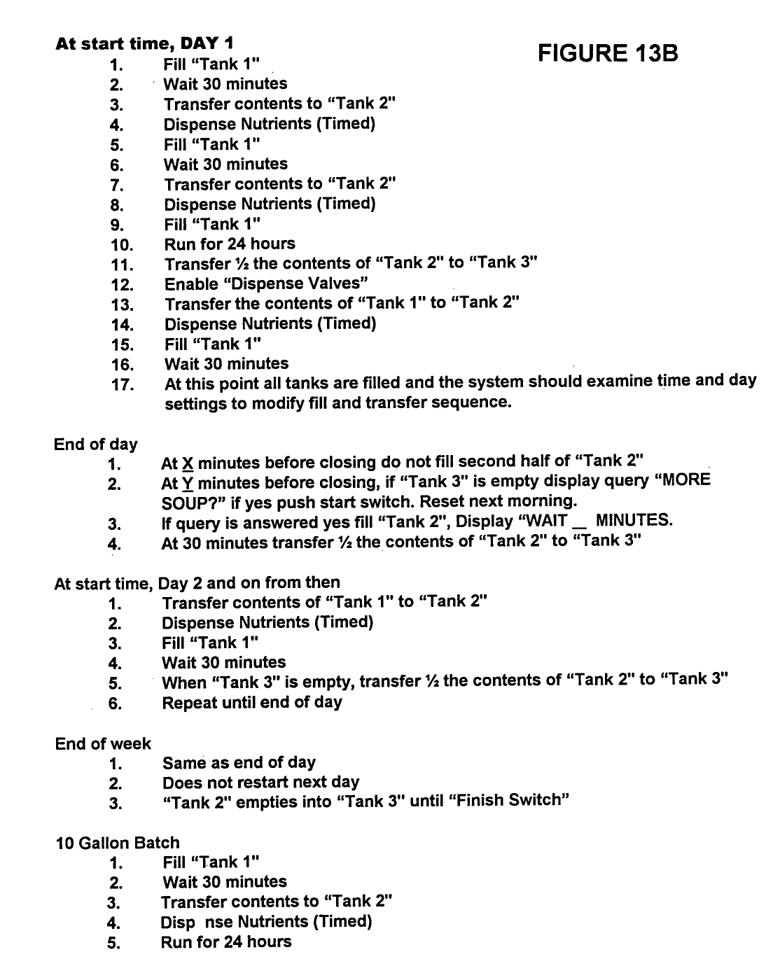

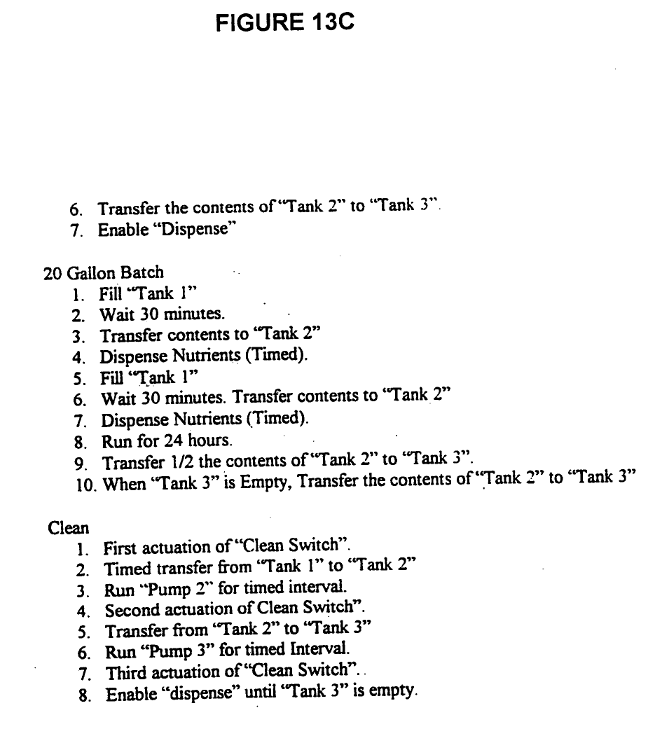

Yet a further embodiment of the invention is illustrated in FIGS. 12 and 13. In this embodiment, a liquid compost material or “tea” is produced on a semi-continuous basis as opposed to individual batches of such material being produced.

Referring to FIG. 12, a semi-continuous process for the production of liquid compost or “tea” is shown generally at 900. It comprises three(3) tanks 901, 902, 903, each of the three(3) tanks using a nozzle 904, 905, 906, respectively, which nozzles are used for stirring and aeration of the liquid within each of the tanks 901, 902, 903. The volumes of the tanks also differ with the first tank 901 and the third tank 903 having the same volume and the second or intermediate tank 902 having a volume twice that of the other two tanks 901, 903.

Each of the tanks 901, 902, 903 has a different function. First tank 901 is used to heat the incoming water and to aerate such water with nozzle 904 in order to remove any chlorine within the water. The second tank 902 is intended to brew the liquid compost material or tea itself from a starter material added at the beginning of a production cycle with water added from the first tank 901 and a nutrient added automatically as a food source for the solution. The third tank 903 is used as a holding tank to hold the compost liquid product or tea removed from the second tank 902 and to subsequently provide the product to a dispensing area generally illustrated at 941.

A nutrient solution is added from a circuit generally illustrated at 930. The nutrient circuit 930 comprises a pair of nutrient holding containers 931, 932 which containers are associated with level switches 916, 917, respectively. A pair of pumps 933, 934 are also associated with the respective nutrient containers 931, 932 and act to add the nutrient solution in a specific quantity to the second tank 902 through piping 940.

A series of level switches 910, 911, 912, 913, 914 and 915 are associated with the respective tanks 901, 902 903. These level switches are used to initiate and to terminate certain functions when the brewing process is automated as will be described. A solenoid operated valve 923 is associated with first tank 901 and is used to admit or terminate the entrance of water to first tank 901. A second valve 924 is associated with the third tank 903 and again, is used to control the entry of liquid to third tank 903.

Heaters 950, 951 are associated with first and second tanks 901, 902, respectively. The heaters 950, 951 raise the temperature of the liquid within the respective tank to an optimum value such that aerobic bacterial breakdown or brewing is facilitated. Pumps 952, 953, 954 are likewise associated with each of the tanks 901, 902, 903, respectively. Pump 952 is used to transfer liquid from first tank 901 to second tank 902. Pump 953 is used to transfer liquid from second tank 902 to third tank 903 and pump 954 is used to transfer the liquid compost product to the compost dispensing area 941. The pumps 952, 953, 954 are also used for aeration and circulation through the nozzles 904, 905, 906.

The dispensing area 941 comprises two spigots 942, 943 with a valve 944, 945 associated with the respective spigot 942, 943. The valves 944, 945 are intended to be opened or closed by a user having a container (not illustrated) which container will be held beneath the spigot 942, 943 associated with it's respective valve 944, 945 when one of the valves 944, 945 is opened in order to release the liquid compost material or tea and fill the container.

In operation, it will be assumed that the product is intended to be sold the day following from the startup of the semi-continuous process of producing the liquid compost material or tea. This day, in gardening centers of the normal variety, will typically be a Monday as the most product is usually sold on weekends which usually are is a peak selling days throughout the week and reference is made to the sequence listing of the control system of FIGS. 13A, 13B and 13C.

Valve 923 associated with tank 901 is opened to allow the ingress of water to the tank 901. When level switch 911 indicates the tank is full, the heater 950 and the pump 952 feeding the aerating nozzle 904 are initiated. The aeration caused by nozzle 904 allows chlorine in the water introduced into the first tank 901 to be removed or very substantially reduced. The de-chlorinated water is then held at an optimum temperature for aerobic breakdown within tank 901.

A compost “starter” material is introduced into second tank 902. Valve 960 is switched on and the heated and de-chlorinated water from tank 901 is pumped into second tank 902 until level switch 912 is activated. The first tank 901 fills and empties twice to fill the second tank 902, the volume of the second tank 902 being conveniently twice the volume of the first tank 901 since the brewing action takes place within this tank 902 and provision must be made for only partial removal of the tea from this tank 902 following the brewing operation.

Nutrients or “food” material for the brewing process are added to second tank 902 from the nutrient circuit 930 as a “charge”. To add the liquid nutrients, pump 934 is initiated and the dispensation of nutrient material from nutrient container 932 occurs at a controlled rate into second tank 902. Level switch 917 indicates when the nutrient container 932 is empty at which time pump 934 will terminate operation and pump 933 will initiate operation thereby drawing nutrient material from a backup or second nutrient container 931 assuming that level switch 916 indicates liquid nutrients are still held by container 931. During the pumping action of pump 933, the empty first nutrient container 932 is replaced and, when level switch 916 indicates nutrient container 931 is empty, pumping action will again switch back to pump 934 and nutrient material will be removed from the new container 932.

The brewing or bacterial breakdown process is conveniently designed to take approximately a twenty-four(24) hour period in second tank 902 while the heater 951 maintains the liquid, the nutrient material and the starter material at the desired and optimal brewing temperature. The solution continues to be aerated by way of nozzle 905.

At the end of the twenty-four(24) hour brewing period, conveniently taking place at a time of slow or reduced business within the garden center or at night, approximately one-half of the brewed liquid is pumped into third tank 903 by opening valve 924 with pump 953 running to provide aeration and circulation. The third tank 903 will be filled with the liquid compost material or tea and the valve 924 will be closed to restrict further liquid entry.

The second tank is then refilled with the heated and de-chlorinated water from first tank 901 by valve 960. The water passes to second tank 902 and again fills tank 902. Nutrients are continuously added to second tank 902 from the nutrient circuit 930. In the interim, users are encouraged to fill and do fill their containers from the spigots 942, 943 which spigots output the liquid compost material passing through the valves 914, 915 under the influence of pump 954.

During the brewing of the second batch within the second tank 902, however, and as discussed above, the duration of brewing has been found to be only a fraction of the initial twenty-four(24) hour period needed for the initial brewing. Accordingly, the second batch may take only approximately thirty(30) minutes to complete in order to obtain an entirely acceptable compost liquid material or tea. So long as the aeration by way of pumps 953, 954 and nozzles 905, 906 continues, the compost tea can be held for an extended and indefinite period without a significant reduction in quality. The process continues so long as conveniently desired.

The process can easily be automated and controlled by a microprocessor (not illustrated) which is programmed according to the sequence listings of FIG. 13A to 13C. The microprocessor commands the action of pumps 952, 953, 954 according to whether the level switches 912, 914, 915 indicate fluid is present in the respective tanks 901, 902, 902. Likewise, the heaters 950, 951 and the various valves are also under the control of the microprocessor which will terminate operation of the heaters and the pump and aerators when no liquid is present. The microprocessor will have a real time clock associated with it where the liquid introduced to the first tank 901 and moved into second and third tanks 902, 903 is done at predetermined time intervals so that the process is automated to a large degree without the need for substantial manual overview other than adding the initial starter material to the second tank 902 and other than replacing the nutrient containers 931, 932.

Many modifications will readily occur to those skilled in the art to which the invention relates. A 50% withdrawal of the tea from tank 902 is only a convenient quantity to use and a greater or lesser quantity is available. Experiment data indicates that regeneration will occur in fifteen(15) minutes if 25% of the tea is removed from second tank 902, thirty(30) minutes if 50% of the tea is removed and one(1) hour is 75% of the tea is removed. These regeneration figures result from experimental data which measure the bacterial population density within the tank 902 but, of course, only a time based system is used according to the invention.

While specific embodiments of the invention have been described, such embodiments should be taken as illustrative of the invention only and not as limiting its scope. Many modifications beyond those specifically described will readily occur to those skilled in the art to which the invention relates and the scope of the invention, therefore, should be defined in accordance with the accompanying claims.

I claim:

1. Method for the production of a liquid compost material used as a soil amendment or soil treatment comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material and removing a predetermined quantity of said liquid compost material as a product following said predetermined time period.

2. Method according to claim 1 and further comprising maintaining said water, said nutrients and said starter compost material within said water holding tank at an optimum brewing temperature to facilitate bacterial breakdown of said starter compost material.

3. Method according to claim 2 and further comprising adding water and nutrients to said water holding tank following removal of said predetermined quantity of said liquid compost material from said water holding tank and continuing to aerate said water and said nutrients in said water holding tank for a second predetermined time period to facilitate bacterial breakdown and to form said liquid compost material or tea and removing a further predetermined quantity of said liquid compost material when said bacterial breakdown is substantially finished and said liquid compost material is formed.

4. Method as in claim 3 wherein said water is introduced from a first tank, said water in said first tank being heated and aerated to de-chlorinate said water added to said first tank.

5. Method as in claim 4 wherein said liquid compost material is removed from said water holding tank to a third holding tank, said liquid compost material in said third tank being aerated while in said third holding tank.

6. Method as in claim 5 wherein nutrients are added to said second tank by way of a nutrient addition circuit.

7. Method as in claim 6 wherein said water is moved from said first tank to said water holding tank and said liquid compost material is moved from said water holding tank to said third tank by pumps and valves under the control of a microprocessor.

8. Method as in claim 7 wherein the presence of water in said first tank and the presence of liquid in said water holding and third tanks is sensed by liquid sensors.

9. Method as in claim 1 wherein nutrients are added to said water holding tank following removal of said liquid compost material from said liquid holding tank.

10. Method for the production of a liquid compost material used as a soil amendment or soil treatment comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material, removing a predetermined quantity of said liquid compost material as a product following said predetermined time period and adding a second charge of nutrients to said water holding tank following said removal of said quantity of said liquid compost material.

11. Product produced by any one of the methods of claims 1-10.

12. Apparatus for producing a liquid compost material used as a soil amendment or a soil treatment comprising a first liquid and starter compost holding tank, a water addition apparatus for adding water to said tank, a nutrient addition apparatus for adding nutrients to said tank, an aerator for aerating the contents of said tank, a timer for indicating the elapse of a predetermined time period wherein bacterial breakdown of said starter compost and added nutrients is substantially complete and said liquid compost material has been produced and a liquid compost removal apparatus for removing a quantity of said liquid compost material following said predetermined time period.

13. Apparatus as in claim 12 and further comprising a second tank to hold said liquid compost material from said first tank and an aerator within said second tank to aerate said liquid compost material while said material is held in said second tank.

14. Apparatus as in claim 13 and further comprising a third tank to hold water, a pump to move said water to said tank, an aerator to aerate said water in said third tank to de-chlorinate said water and a heater to heat said water in said third tank to an optimal temperature for bacterial breakdown.

15. Apparatus as in claim 14 and further comprising a nutrient addition system to add nutrients to said tank containing said water and said starter compost material.

16. Apparatus as in claim 14 and further comprising a microprocessor to automatically move said liquid compost material from said tank to said second tank and to move said water form said third tank to said tank.

17. Apparatus as in claim 14 and further comprising pumps and valves associated with said tank, said second tank and said third tank, said pumps and valves being under the control of said microprocessor.

18. Apparatus as in claim 15 and further comprising a dispensing area, said dispensing area receiving said liquid compost material from said second tank and being operable to dispense said liquid compost material.

19. Apparatus for producing a liquid compost material used as a soil amendment or a soil treatment comprising a first liquid and starter compost holding tank, a water addition apparatus for adding water to said tank, a nutrient addition apparatus for adding nutrients to said tank, an aerator for aerating the contents of said tank, a timer for indicating the elapse of a predetermined time period wherein bacterial breakdown of said starter compost is substantially complete and said liquid compost material has been produced, a liquid compost removal apparatus for removing a quantity of said liquid compost material following said predetermined time period from said tank and a nutrient addition apparatus for adding a second charge of nutrients to said tank following removal of said quantity of liquid compost material after said predetermined time period.

20. Method for the production of a liquid compost material used as a soil amendment or soil treatment, said method comprising the steps of adding a quantity of water to a water holding tank containing a starter compost material, adding nutrients to said tank in a predetermined quantity to stimulate microbial growth in said tank, aerating said liquid, said compost material and said nutrients for a predetermined time period to stimulate bacterial breakdown and to form said liquid compost material, removing a predetermined quantity of said liquid compost material as a product following said predetermined time period and adding a second charge of nutrients to said water holding tank following said removal of said quantity of said liquid compost material.

21. Apparatus for producing a liquid compost material used as a soil amendment or a soil treatment comprising a first liquid and starter compost holding tank means for holding said first liquid, starter compost and nutrients, a water addition means for adding water to said tank, a nutrient addition means for adding nutrients to said tank, an aerator means for aerating the contents of said tank, a timer means for indicating the elapse of a predetermined time period wherein bacterial breakdown of said starter compost is substantially complete and said liquid compost material has been produced, a liquid compost removal means for removing a quantity of said liquid compost material following said predetermined time period from said tank and a nutrient addition means for adding a second charge of nutrients to said tank following removal of said quantity of liquid compost material after said predetermined time period.
